(19) United States
(12) Patent Application Publication
(10) Pub. No.: US 2022/0281173 A1
(43) Pub. Date: Sep. 8, 2022

(54) PROCESS AND DEVICE FOR PREPARING PLATES FOR CYLINDERS TO TREAT ITEMS OF THE PAPER PROCESSING INDUSTRY

(71) Applicant: SEI S.p.A., Curno BG (IT)

(72) Inventor: Ettore FUSTINONI, Curno BG (IT)

(21) Appl. No.: 17/628,413

(22) PCT Filed: Jul. 22, 2019
(86) PCT No.: PCT/IB2019/056252

§ 371 Date: Jan. 19, 2022

(51) Int. Cl. B29C 64/386; B41N 1/12; B29C 64/118; B33Y 10/00; B33Y 50/00

(52) U.S. Cl. CPC B29C 64/386; B41N 1/12; B29C 64/118; B33Y 10/00; B33Y 50/00; B29K 2067/003

(57) ABSTRACT

A process for preparing plates (22,32) for cylinders (20,30) to treat items of the paper processing industry (40) is described, the process comprising the following steps: acquisition of a treating pattern (50) to be produced on the item of the paper processing industry (40); creation of a 3D reference model of the treating profile elements (25, 35) according to the treating pattern (50); application of the treating profile elements (25,35) on the plate (22,32) by means of an additive manufacturing process of polymeric material, preferably thermoplastic polymeric material, in accordance with the 3D reference model of the treating profile elements (25, 35), carried out by means of at least one printing nozzle (80) of said polymeric material. A device (250) for preparing plates (22,32) is also described, in addition to a plate (22,32) to treat items of the paper processing industry comprising at least one treating profile element (25,35) of polymeric material, preferably thermoplastic polymeric material, deposited on said plate by means of an additive

### FIELD OF THE INVENTION

The present invention relates to a process and a device for preparing plates adapted to be fixed to the outer surfaces of cylinders to treat items in the paper processing industry. It should be noted immediately that the term “paper processing industry” is herein and in the following used to designate the field of the art providing for the use and transformation and/or decoration of cardboard, card stock and like materials, for example for making cards, postcards, as well as to be folded to make boxes, receptacles and the like for example for packaging and micro-packaging, and for the impression of decorations, or wording, or symbols on said materials, from portions of material that are appropriately treated, namely folded, cut and/or decorated.

The expression “treating of items of the paper processing industry” is herein and in the following used to indicate processes such as, for example, creasing or embossing of cardboard, card stock, and like materials.

### KNOWN PRIOR ART

It is known that processes are carried out on items in the paper processing industry, such as creasing, i.e. folding lines made on cardboards or card stocks, to aid their folding and avoid deformations and cracking, or embossing, namely incisions or impressions, of a simple motif or design on cardboards or card stocks. Creases and embossing can be made by using projecting profiles and if necessary corresponding hollow profiles arranged on respective metal plates fastened on counter-rotating rollers. The portion of cardboard or card stock to be treated, generally having a rectangular shape, once interposed between the counter-rotating rollers, is shaped and impressed or incised by means of the projecting profiles coupling with the relative hollow profiles.

Therefore, in the systems to treat cardboards or card stocks, the use of counter-rotating rollers on whose surfaces projecting profiles and relative hollows are arranged is known.

Document US 2004/0214703 describes a machine for creasing items of the paper processing industry provided with two counter-rotating cylinders accommodating flexible metal plates which, in turn, have projections and hollows adapted to carry out the treating of cardboards and card stocks.

One of the cylinders is provided with projections, whereas the opposing cylinder is provided with seats or hollows (and in general recesses) corresponding to said projections. The projections and hollows cooperate to carry out the treating of cardboards and card stocks.

In such a machine the metal plate provided with the projections is, for example, made to adhere magnetically to the first cylinder, and the second plate, provided with the hollows, is stuck to the second cylinder.

Such machines have the drawback of being not particularly versatile, since the projections/hollows are provided in one piece with the plates used on the counter-rotating cylinders and thus require complete replacement of the plate having a different arrangement of projections/hollows to carry out a different treating pattern. Therefore, the machine cannot be quickly adapted and modified for making different treating patterns.

In order to address this drawback, treating profiles for creasing are used, which are applied, for example by means of adhesive, on the plates which in turn are installed on counter-rotating cylinders.

For example, ink printing machines are known, which are modified to carry out treating operations. More in detail, a profile band and a counter-profile band corresponding to the first one are installed on the two cylindrical surfaces of the counter-rotating rollers. The positioning of the profiles and counter-profiles (projections/hollows, also known as male and female type profiles) is carried out by gluing adhesive profiles on plates that are secured to the surface of the counter-rotating printing rollers by the interposition of a further supporting plate.

Although such an arrangement of adhesive profiles allows greater versatility and adaptability of the machine with respect to the other known treating machines carrying profiles made in one piece with the plates, not even such a system is free from drawbacks.

In fact, the manual application of the adhesive profiles, for example with the aid of a reference grid, has to be done very precisely and accurately, at the risk of mistakes in the perfect match of projections/hollows and in general of female type profiles with the corresponding male type profile.

The need to arrange the profiles in the correct position on two different plates in order to obtain the desired pattern to treat the card stock, in addition to requiring high precision by the operator carrying out said operation, causes undesired prolongation of the time necessary for carrying out such operations, which can even amount to a few hours, for example in the case of very large plates and/or complex and detailed treating profiles.

In order to address this drawback, the Applicant has developed a process and a device for obtaining treating profiles of items of the paper processing industry, for example for creasing items of the paper processing industry, through semi-automated processes, in which a reference sheet is positioned on the plates, and incised with a laser according to a pre-selected pattern in order to produce openings adapted to accommodate the creasing profile elements, which are manually glued by an operator.

Said system allows greater precision and accuracy in arrangement of the profile elements, due to the use of the laser, compared to the known processes and devices.

From the document EP2572037B1 the arrangement of treating profiles by means of polymerizable material is also known. Said polymerizable material is extruded in the required profile and then undergoes crosslinking/curing.

The need to carry out crosslinking/curing of the polymerizable material, in addition to prolonging the time required for production of the treating profile, does not allow the desired shape of the treating profile to be obtained accurately and precisely, in particular when the dimensions of the profile are reduced.

In fact, the crosslinking/curing phase of the polymerizable material produces undesired effects. In particular, the crosslinking/curing phase causes modification of the shape and therefore the dimensions of the polymerizable material with respect to the extruded shape. Consequently, at the end of the crosslinking/curing, the shape and the dimensions of the profile will not necessarily correspond to the desired shape and dimensions.

Furthermore, in the extrusion process with subsequent curing of polymerizable material, the shape (and in particular the section) of the extruded material necessarily depends on the shape of the extrusion section. This necessary feature of the extrusion process inevitably restricts the obtainable shape to the extrusion shape.

The object of the present invention is to further improve the process and the device for preparing plates, further reducing the time necessary for preparing the plates in addition to increasing the versatility of the preparation process and device, guaranteeing high precision in the shape and dimensions of the treating profile produced.

In this regard, it should be noted that nowadays, for example in digital printing and in particular in ink jet printing, the need is increasingly felt to make small externally customized batches which therefore require different prints to be made very rapidly. For example, in the packaging and micro-packaging sector, and in particular in the field of packaging luxury products such as perfumes, jewellery, high quality food and beverages, as well as in the production field of brochures or customized folders, there is the need for great flexibility in continuously and rapidly changing the products to be made. The new printing technologies on the market can provide such adaptability but, as seen, the processing suffers from the drawback of not being quickly adaptable on a short timescale to different patterns to be made.

The object of the present invention is to provide a method and a device for preparing treating plates of items of the paper processing industry which allow arrangement, rapidly and simply, and also precisely, of the treating profiles according to the treating pattern to be produced.

A further object of the present invention is to provide a method and a device for preparing treating plates which increase the production precision and flexibility of the different creases required in the various production processes.

A further object of the present invention is to provide a method and a device for preparing treating plates which overcome the above drawbacks due to the need for curing of the material used and the need to carry out a subsequent crosslinking/curing procedure of polymerizable material, which is costly and time-consuming.

A further object of the present invention is to offer the possibility of obtaining treating profiles of the desired shape and dimensions.

### BRIEF SUMMARY OF THE INVENTION

These and other objects are achieved by the process and the device according to the respective independent claims. Further features/aspects of the invention can be inferred from the dependent claims.

In particular, an aspect of the present invention provides a process for preparing plates for treating items of the paper processing industry, said plates being adapted to be used, for example, on cylinders to treat items of the paper processing industry, for example for creasing and embossing of items of the paper processing industry, the process comprising the following steps:

a) acquiring a treating pattern to be produced on the item of the paper processing industry;

b) creating a 3D model of the treating profile elements in accordance with the treating pattern to be produced;

c) applying the treating profile elements on the plate by means of an additive manufacturing process of polymeric material, preferably thermoplastic polymeric material, in accordance with the 3D reference model of the treating profile elements, in which the additive manufacturing process is carried out by means of at least a printing nozzle for printing the polymeric material on the plate.

An advantage of this solution is the fact that it speeds up preparation of the treating machine, and provides greater precision in addition to high flexibility in terms of adaptation to the desired treating pattern.

In fact, the acquisition of the treating pattern to be produced on the item of the paper processing industry allows the rapid and simple creation, for example by means of a modelling software, of a 3D model of the profile elements (namely of the portions or strips of treating profile) to be applied on the plates, according to the desired pattern. The subsequent application of the treating profiles is very simple and precise, since it is carried out by means of an additive manufacturing process, for example a process known in the art as 3D printing or three-dimensional printing, and does not require manual intervention by an operator. An example of said technique is described in U.S. Pat. No. 5,121,329.

Furthermore, different treating profiles can be quickly transferred onto the plates as required, making preparation of the treating plates rapid and simple, and also very reliable.

In particular, the additive manufacturing process is carried out by means of the deposition of polymeric material, preferably thermoplastic polymeric material, in layers or successive segments, by means of a deposition (or printing) nozzle; the layers are added one with another (for example by stacking) until the desired profile is obtained.

According to one aspect, two or more layers are deposited, preferably three or more superimposed layers.

This technique allows the desired shape of the treating profile elements to be obtained in a precise and reliable manner.

In fact, according to one aspect of the present invention, the additive manufacturing process allows, by deposition of at least two layers of polymeric material, preferably a plurality of layers of polymeric material, precise formation of the treating profile elements having the desired shape and dimensions. Unlike the known extrusion processes as described in EP2572037B1, according to the present invention the treating profile section does not depend on the section of the printing nozzle.

In particular, the section of the treating profile elements thus obtained is very accurate. In fact, the deposition of successive quantities of polymeric material in the additive manufacturing process advantageously allows the treating profile elements to be formed without the need to carry out further steps after deposition of the polymeric material such as, for example, crosslinking/curing which are necessary, on the other hand, if polymerizable material is used as described, for example, in the document EP2572037.

Advantageously, the process and the device according to the present invention provide high quality treating of items of the paper processing industry. In fact, an item of the paper processing industry is a quality item if the treating thereof (for example creasing) has been carried out precisely and accurately, in particular it must comply with certain requirements, for example the folding must be definitive, in other words once carried out, the item of the paper processing industry remains in the configuration acquired during the treating process. Furthermore, the folds on the item of the paper processing industry must be precise, without wrinkles or splits. A further requirement which the treating of an item of the paper processing industry must comply with is that of creating the desired folds while keeping intact the features of mechanical strength of the item, namely the creasing profiles must impress the desired folding on the item exerting an adequate pressure or force, and such that the cardboard or card stock does not break in the area of the folds made, for example when subjected to repeated opening and closing cycles by a user.

The present invention advantageously allows male and female treating profiles to be obtained with a high accuracy in terms of shape and dimensions which, as said, are necessary requirements for the quality treating of items of the paper processing industry.

It should be noted that the term treating pattern is used here to indicate the design formed by the geometric shapes and/or by the lines and/or by the dots to be created on the card stock, or similar item of the paper processing industry being treated. For example, the treating pattern can comprise a plurality of lines for the creation of creasing profiles and/or a plurality of dots for embossing and/or for producing Braille symbols. If the treating to be carried out is the embossing of shapes, the pattern comprises one or more lines, and in general a shape, which corresponds to the shape of the elements of the pattern or the shape to be impressed.

Below, the profile elements (i.e. the portions of treating profile) can be indicated also simply as treating profiles, with reference both to male profiles, namely provided with a projecting portion, and female profiles, namely provided with a hollow or recess, and also with reference to reciprocally coupled male and female profiles.

It should also be noted that the wording acquisition of the treating pattern is used here and below to indicate that the 3D model of the treating profile elements is created based on (as a function of) the pattern or design comprising the treating geometric shapes, or the lines or the dots (or a combination thereof). In other words, the pattern or design comprising the treating geometric shapes, or the treating lines or the dots (or a combination thereof) is preferably used as an input datum to create the 3D model of the treating profile elements that will be applied on the plates by means of the polymeric material additive manufacturing process.

It should be noted that creation of the 3D model, and therefore its generation or modelling, can be performed in a known way by means of three-dimensional modelling software based on the treating pattern to be carried out on the item of the paper processing industry.

It should be noted that according to a possible embodiment, the treating pattern can be made available, and therefore acquired, by a control unit for example by means of storage in a memory unit or the pattern can be transferred to the control unit in a known way. The treating pattern can, for example, be contained in a file, for example of pdf or other type, which can contain other information for example relative to the graphics to be printed on the card stock, the die-cutting lines of the card stock, etc. For example, the treating pattern can represent a layer of a file containing other information.

The 3D model of the treating profile elements to be applied to the plates is created based on the treating pattern of the lines, dots and shapes (or a combination thereof) acquired (for example provided as input data).

It should be noted that according to one aspect of the invention, the 3D reference model of the treating profile elements is determined according to the treating lines, dots, shapes (or a combination thereof) of the pattern to be created (for example by means of a modelling software of the control unit); according to said 3D reference model, the additive manufacturing process, and in particular a 3D printing process, of said treating profile elements is carried out directly on the plates. In particular, the dimensions and/or the shape of the profile elements are determined (for example by means of a software of the control unit) according to the treating lines, dots, shapes (or a combination thereof) of the pattern to be produced.

It should be noted that, according to an aspect of the invention, the 3D reference model can be produced by scanning an existing real model in order to reproduce the treating profile of the latter. Said scan can be performed by means of a 3D scanner. In this case, the treating pattern is acquired by making the existing real model available and performing the scan, for example by means of 3D scanner.

According to an aspect of the present invention, the treating profile elements are printed, directly on the plate, by means of a 3D printing process, in particular by means of an additive manufacturing technique such as, for example, fused deposition modelling (FDM).

It should be noted that, due to said manufacturing technique, the treating profile elements are deposited and then printed on the plate preferably by means of a plurality of layers, deposited in succession, layer after layer. According to one aspect, the additive manufacturing process is performed by a device for preparation of the plates (below indicated for the sake of simplicity also by the term plate preparation 3D printer) which comprises at least one nozzle, preferably heated; alternatively the polymeric material is fed in solid form (for example in the form of a strip, filament or wire) through a heating chamber before reaching the printing nozzle.

The polymeric material is deposited on the plate in the form of a filament or wire in a substantially fused state. The filament or wire of material is deposited on the plate, to which it adheres, cooling and solidifying, i.e. returning to the solid state.

According to an aspect, the polymeric material deposited on the plate is printed by a nozzle, preferably a heated nozzle, and delivered by known means, for example a motor, through the nozzle.

According to an aspect of the present invention, the material of the plate and the material deposited on it are chosen so as to allow high adhesion and such as to withstand longitudinal and transverse compression forces and shear strain applied on the treating profile.

According to an aspect of the present invention, the material of the plate and the material deposited on it are chosen such as to have similar fusion temperatures, preferably they are chosen such as to determine a surface (micro)fusion of the plate and the reciprocal diffusion of material when the material for formation of the treating profile is deposited on the plate.

According to an aspect of the present invention, the printed material is a polymeric material, preferably thermoplastic, more preferably PETG.

According to an aspect of the present invention, the plate on which the polymeric material is deposited is also made of polymeric material, preferably PVC.

The applicant has ascertained that the process according to the present invention and in particular the use of polymeric material, preferably thermoplastic, more preferably PETG deposited on plates made of polymeric material, preferably PVC, allows excellent results to be obtained in terms of adhesion of the treating profiles on the plate and therefore does not require heating of the plate and/or the use of additives. In other words, according to an aspect of the present invention, the printing operation of the treating profiles preferably does not need to be preceded by a step of preparation of the plates, which consists in heating thereof and/or in the addition of additives on their surface.

Advantageously, the fused polymeric material (preferably PETG) which is printed on the plate, and the component material of the plate (preferably PVC) have similar fusion temperatures, which determines a surface (micro)fusion of the plate and the reciprocal diffusion of material between the plate and the first layer of fused material. Due to this phenomenon, the adhesion of the creasing profile and the plate is sufficiently high and such as to withstand longitudinal and transverse compression forces and shear strain which are applied to the treating complex during treating of an item of the paper processing industry, preventing the treating profiles from moving or detaching due to the pressure and rotation applied to the treating cylinders.

Advantageously, this also avoids a further step of UV crosslinking/curing of the printed polymeric material to promote adhesion thereof to the plate, as for example described in the document EP2572037.

As said, an advantage of the present invention is that it allows improved adhesion of the treating profiles which are deposited and then printed directly on the plates, avoiding undesired effects such as total or partial detachment of the first layers of deposited material, or undesired bending of the printed profile element; said undesired effects would make the printed profile unusable.

Advantageously, the additive manufacturing process, and in particular the 3D printing process, allows customized profile elements to be rapidly produced, in other words the 3D printing process allows the production of a plurality of shapes and dimensions of the treating profiles, according to the pattern to be reproduced.

According to an aspect of the present invention, the treating profile elements are deposited and then printed so as to comprise several superimposed layers (obtained by depositing the polymeric material in superimposed layers) so as to comprise a lower support portion and an upper portion which is projecting (in the case of a male profile) or hollow (in the case of a female profile). It follows that, according to the treating pattern, the dimensions/shape of the treating profile elements to be applied and the distance to be maintained between each element during the printing operation are advantageously determined, in order to correctly reproduce the treating pattern.

It should be noted that, according to an aspect of the invention, the 3D reference model is created according to the treating pattern, and possibly according to the type of profile elements to be applied to the plate, for example according to the dimensions and/or shape of the support of the treating profile element that carries the projecting portion or the hollow.

Advantageously, the process according to the present invention allows both male treating profiles (known in the art as creasing system), and female treating profiles (known in the art as counter creasing system) to be produced, in addition to profiles suitable for embossing and the formation of Braille signs. It should be noted that male and female type profiles can be deposited by means of the additive manufacturing process in a rapid, simple and accurate manner respectively on two plates adapted to cooperate in the treating machine to treat items of the paper processing industry, for example provided with two counter-rotating cylinders.

According to an aspect of the present invention, it is possible to use two or more polymeric materials different from one another to produce the treating profile elements. In other words, the treating profile elements can be produced by means of the deposition of two or more polymeric materials different from one another.

Alternatively or in combination, the same polymeric material can be deposited on the plate using different deposition parameters.

It should be noted that the treating profile production method according to the invention allows direct application of the profiles on the plates by means of an additive manufacturing process, and in particular 3D printing, starting from a 3D modelling file, without the need for an intermediate process step such as, for example, the application of a mask on the plates to determine the application point of the profiles.

According to an aspect of the present invention, the plates can comprise metallic material, or magnetized polymeric material, preferably they are made of PVC sheets, preferably magnetic.

According to one aspect, in the material deposition step and the printing step the plate is kept in position on a support which can be integrated in the 3D printer used, or can be an external support, so that the relative position between the plate and said support is maintained. For example, according to one embodiment, the plate can be removably secured on a heated support surface of the 3D printer.

In a further embodiment, the support for the plate can be a cylindrical support, and in the printing step the plate is kept in position on said cylindrical support, so that the relative position between the plate and said cylindrical support is maintained.

Said cylindrical support has preferably the same dimensions as the machine cylinder, so that the deposition (or printing) step of the treating profiles on the plate is carried out taking into consideration the curvature of the treating cylinders on which said plate, with the relative treating profiles, will be fixed.

According to one aspect, the cylindrical support can be the same treating cylinder of the machine used for treating the items of the paper processing industry and the plate is removably secured to the treating cylinder.

As said, according to an aspect of the present invention, the treating profile elements are positioned on the plates by means of an additive manufacturing process, and in particular by means of a 3D printing process.

The use of said process, and in particular of a 3D printer, has the advantage of guaranteeing high precision in addition to production speed of the treating profile elements, avoiding the intermediate process steps (manual application of a mask, manual determination of the perimeters for the treating profiles) which are subject to human error and which could compromise correct application of the treating profile elements on the plate.

Furthermore, depositing (printing) the treating profiles directly on the plate fixed to a cylindrical support or to the machine treating cylinder has the advantage of guaranteeing greater precision in application of the profiles, which takes account of the curvature of the cylindrical treating surface.

As said, according to an aspect of the present invention, the 3D reference model is created in such a way as to take account of the shape and/or dimensions of the male/female profile elements to be applied to the plate and the relative position that must be maintained between them on said plate.

In fact, as discussed above, according to an aspect of the present invention, as a function of the shape and/or dimensions of the treating profiles, for example if they comprise hexagonally shaped supports (support portions), the 3D model will be determined so as to realize the treating lines of the acquired pattern.

According to a further aspect, the 3D model can be determined so as to impress a decorative pattern or wording on the material to be processed.

Advantageously, said configuration can be used, for example, to impress tactile Braille symbols.

A further aspect of the present invention concerns a device for preparing plates for cylinders to treat items of the paper processing industry.

The device comprises at least a printing (deposition) nozzle of polymeric material, preferably thermoplastic polymeric material, on at least a plate by means of an additive manufacturing process for the production of treating profile elements according to a 3D model of the treating profile elements.

According to one aspect, the device comprises a control unit adapted to acquire a pattern of the treating lines to be made on the item of the paper processing industry; a control unit which can coincide with the first one or be separated from the first one, for developing a 3D model of the treating profile elements according to the treating pattern.

According to an aspect, the device comprises at least one supporting plane or a cylindrical support for the plate, and the nozzle is movable along at least one axis (X), preferably on a plane (X-Y) substantially parallel to the surface on which the plate lies.

According to an aspect of the invention, the printing nozzle moves relative to the supporting plane (or relative to the cylindrical support) in a plane (X-Y) parallel to said supporting plane (or to a plane tangent to the surface of the support cylinder), while the supporting plane (or the support cylinder) moves along an axis Z perpendicular to the plane X-Y.

It should be noted that, according to a further aspect, the cylindrical support can be the treating cylinder itself of the machine for treating items of the paper processing industry. In other words, according to an aspect of the invention, the treating profile elements can be deposited by means of additive manufacturing on the plate directly mounted on the cylinder of the machine for treating items of the paper processing industry.

It should be noted that the plate support cylinder (which as said, can correspond to the machine treating cylinder) can rotate around its own central axis to allow deposition of the material on the plate supported by it.

The support plane (or the support cylinder) comprises means for maintaining in position the plate positioned on it in the desired position, avoiding undesired movements, due for example to the vibrations produced by the 3D printer during the printing process.

According to a possible embodiment the plate is magnetically fixed to the support plane or to the cylindrical support or to the metallic treating cylinder, and is preferably made of filled PVC so as to have metallic-magnetic behaviour, or other magnetized polymer.

Said means for maintaining in position can be, for example, of suction means, or reference pins, or locking magnets or other mechanical methods.

Advantageously, as already discussed with reference to the process, direct application of the treating profile elements on the plates, preferably by means of an additive manufacturing process, and in particular by means of 3D printing, allows the treating plates to be produced rapidly and simply and at the same time very accurately according to the desired pattern of the treating lines.

Advantageously, direct application of the treating profile elements on the plates, preferably by means of an additive manufacturing process, and in particular by means of 3D printing, with the plate supported on a support cylinder which replicates the treating machine cylinder, or directly on the treating machine cylinder, allows the curvature of the work surface, namely of the treating cylinder, to be taken into account.

In this way, the treating machine on which the plates are installed is very versatile and can be quickly adapted to the different patterns required by the different production processes.

As said, the process according to the present invention can be advantageously carried out with the plate preparation device according to the present invention. Furthermore, it should be noted that aspects/characteristics described/claimed here with reference to the process can be applied to the device, and vice versa.

The present invention also concerns a machine for treating items of the paper processing industry comprising a pair of counter-rotating cylinders on each of which a treating plate can be positioned. The machine is associated with a device for the preparation of plates described and/or claimed here.

A further object of the present invention is a plate to treat items of the paper processing industry, for example adapted to be installed on cylinders for treating items of the paper processing industry, comprising at least one treating profile element for treating polymeric material, preferably thermoplastic polymeric material, deposited on said plate by means of an additive manufacturing process of polymeric material.

Aspects/characteristics described/claimed here with reference to the process and/or the device for preparing the plate can be applied to the plate per se, and vice versa.

### BRIEF DESCRIPTION OF THE FIGURES

Further characteristics and advantages of the invention will be evident from reading of the following description provided by way of non-limiting example, with the help of the figures illustrated in the attached drawings, wherein:

FIG. 1 is a schematic representation of a machine for treating items of the paper processing industry;

FIG. 2 shows an operation for deposit (printing) of the treating profile elements according to the 3D reference model by means of additive manufacturing, according to a possible embodiment of the invention;

FIG. 2a shows a possible embodiment in section of a treating profile element obtained by means of deposition of material according to a possible embodiment of the present invention;

FIG. 2b shows the deposition step of a layer of material according to a possible embodiment of the present invention;

FIG. 3a shows schematically a possible embodiment of the device for the deposition of a treating profile on the plate positioned on a cylindrical support;

FIG. 3b shows schematically a possible embodiment of the device for the deposition of a treating profile on the plate positioned on a support plane;

FIG. 4 shows schematically in section a view of the support plane on which the plate is positioned on which a male treating profile has been produced by means of additive manufacturing, following the process illustrated in FIG. 3b;

FIGS. 4a-4c show some possible section views of treating profile elements produced by means of the process according to the present invention by deposition of several layers of the same material or several different materials;

FIG. 5 shows schematically in section a possible embodiment of a female treating profile deposited on the plate;

FIGS. 5a and 5b show two possible section views of male and female profile elements according to the invention;

FIG. 6a shows two male profiles in an overhead view relatively arranged to form two creasing lines reciprocally inclined by an angle of less than 90°;

FIG. 6b shows schematically in an overhead view a possible embodiment of profiles for embossing of Braille symbols, for example;

FIG. 6c shows schematically in an overhead view a possible embodiment of the combination of profiles for embossing, of Braille symbols for example, and profiles for creasing;

FIG. 7 shows a pair of rollers composed of a first rotating cylinder having a plate provided with a male profile and a second rotating cylinder having a plate provided with female profile; and

FIG. 8 shows a block diagram of a possible embodiment of the process of the invention.

### DETAILED DISCLOSURE OF SOME EMBODIMENTS OF THE PRESENT INVENTION

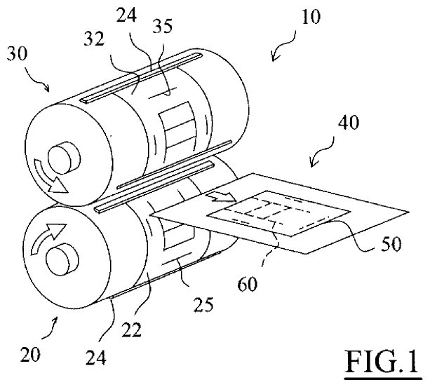

FIG. 1 shows schematically a possible embodiment of a machine for treating items of the paper processing industry, such as cardboard, card stock and like materials, according to an embodiment of the present invention.

The treating is performed by means of the use of a treating machine which comprises a pair of counter-rotating cylinders 10.

The pair of cylinders 10 is composed of a lower cylinder 20 and an upper cylinder 30 which rotate around their own axis of symmetry (central axis) in opposite directions, by means of appropriate movement means not shown.

In one embodiment, on the outer surface of the upper cylinder 30 an upper plate 32 is positioned by fastening means 24, while on the outer surface of the lower cylinder 20 a lower plate 22 is positioned by fastening means 24.

In a further embodiment, the upper plate 32 and the lower plate 22 are positioned on respective cylinders by means of magnetic force.

The upper plate 32 and the lower plate 22 are preferably made of polymeric material, preferably magnetized, more preferably magnetic PVC, or they can be made of flexible metal elements. The plates can have a thickness between 0.2 mm and 3 mm, preferably 2.5 mm, and can be shaped respectively on the outer surface of the upper cylinder 30 and on the outer surface of the lower cylinder 20. Other thicknesses can be used as required. Further materials can be used to produce the plates 22, 32.

In general, the plate 22, 32 can be made of a material, or comprises at least a layer of material, that facilitates the union and therefore bond with the polymeric material which, as will be seen below, is deposited on the surface of the plate.

It should be noted that, according to an aspect, the plate 22, 32 is preferably flexible, namely made so as to adapt to a curved surface, for example to the surface of a cylinder of a treating machine on which the plate is installed.

It should be noted that the term plate is used to indicate a two-dimensional form, namely a flat extension in which two dimensions are dominant with respect to the third dimension, and the plate can therefore comprise a sheet or a film having a single layer or several layers.

On the upper plate 32 elements (portions) of treating profile and in particular male type profiles 35 are applied, preferably deposited (printed) by means of an additive manufacturing process, and in particular by means of a 3D printing process, while on the lower plate 22, elements (portions) of treating profile and in particular female type profiles 25 are printed. Obviously, the opposite arrangement can also be provided, in which the female profiles 25 are printed on the upper plate 32 and the male profiles 35 are printed on the lower plate 22.

According to an aspect, the male type profiles 35 form projections on the upper plate 32, while the female profiles form hollows (recesses) on the lower plate 22. The male profiles 35 and the female profiles 25 are preferably made of polymeric material, preferably thermoplastic, for example PETG.

The creasing profiles of male type 35 and female type 25 are positioned on the respective plates 32, 22 so as to assume a given relative position such that the projections of the male profiles 35 match (are arranged corresponding to) the hollows of the female profiles 32.

The position of the male profiles 35 and the position of the female profiles 32 on the respective plates is therefore determined so that the maximum deviation from the predefined relative position of the male profiles 35 and female profiles 32 is less than 0.15 mm, preferably less than 0.1 mm.

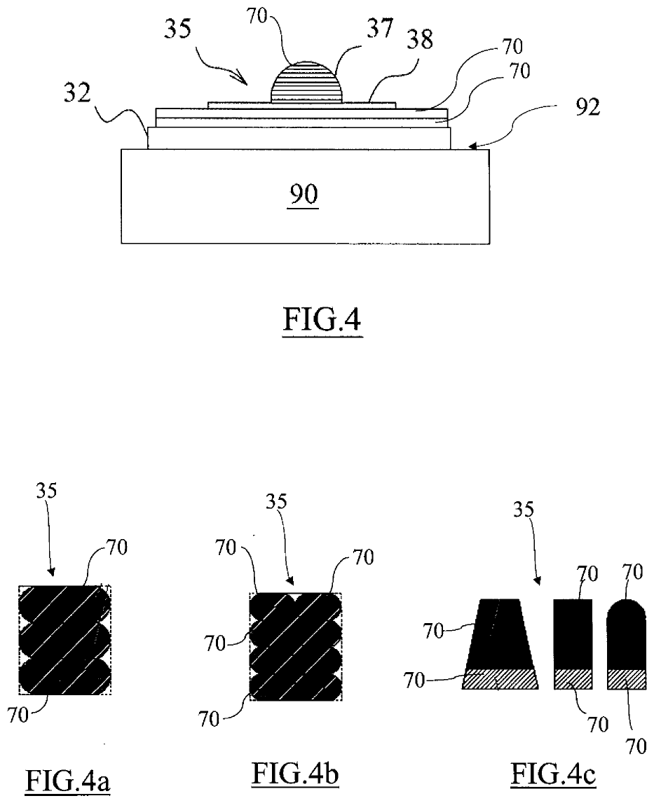

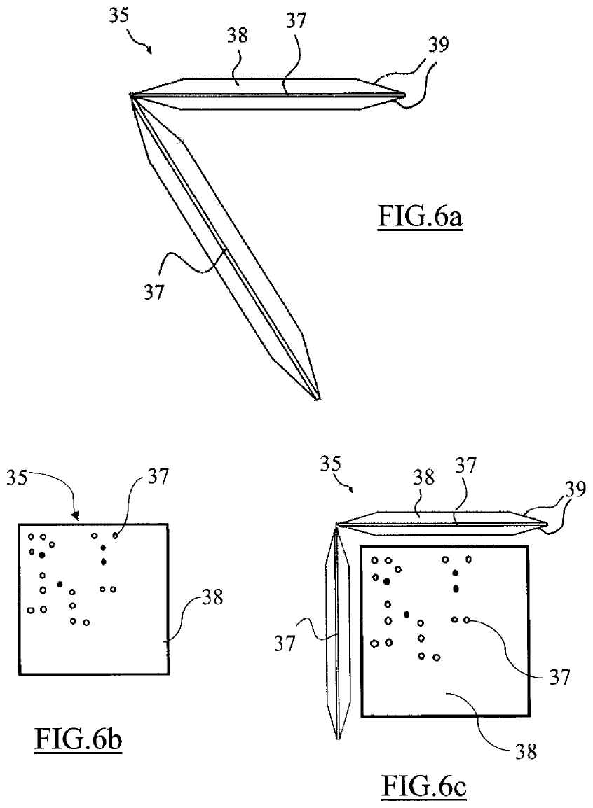

According to a possible embodiment of the machine, adapted for example to a creasing or embossing operation of an item of the paper processing industry, as can be seen, for example, in the overhead view of FIG. 6a and in the section view of FIG. 4, each of the male or female profile elements is preferably printed by the superimposition of several layers 70, namely by means of successive deposition of several layers.

According to a possible embodiment, the male treating profiles 35 and the female treating profiles 25 comprise a lower support portion 38, and an upper projecting portion 37 (for example a rectilinear ridge, or for example a substantially cylindrical or rounded relief, or other substantially convex geometrical shapes for formation of the male profile 35), or said lower support portion 38 is printed so as to present a hollow (for example a rectilinear seat or a circular or rounded seat, or other substantially concave geometrical shapes, adapted to be configured as housing seats for the convex projecting portions 37 of the male elements 35) for formation of the female profile 25.

It should be noted that in a possible embodiment, the lower support portion 38 and the upper portion 37 do not have interruptions.

It should be noted that the support 38 can assume different shapes if seen in an overhead plan view, according to the type of treating desired. For example, according to a possible embodiment adapted to creasing, the plan view shape of the support 38 can be substantially rectangular or (as illustrated, for example, in FIG. 6a) can have for example a hexagonal shape with, at its ends, oblique sides 39 which preferably define an angle equal to or smaller than 90°. In general, the plan view shape of the support 38 of the treating profile can comprise an inclined side.

According to a further possible embodiment adapted for example to embossing an item of the paper processing industry, the plan view shape of the support 38 can be substantially circular or have the profile of the pattern or form to be impressed, as shown for example in FIGS. 6b and 6c.

The elements (portions) of male profile 35 and female profile 25 adhere to the respective plates. In fact, according to a possible embodiment, the male profiles 35 and the female profiles 25 are printed directly on the plate 22, 32 by means of an additive manufacturing process, and in particular by means of a fused deposition modelling process.

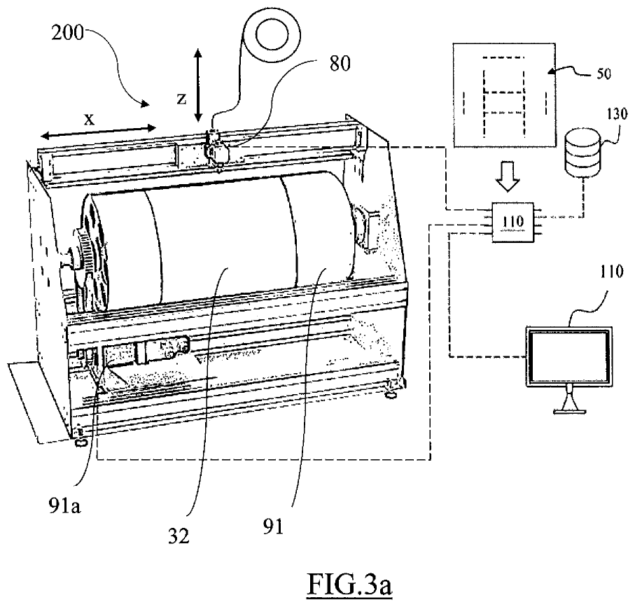

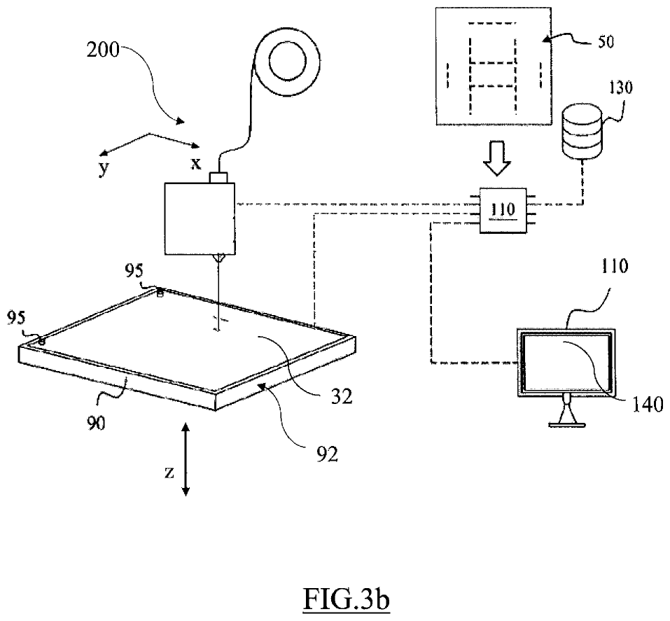

In a possible embodiment shown in FIG. 3b, the male profiles 35 and/or the female profiles 25 are printed directly on the plate 22, 32 positioned on a supporting plane 90.

In a further embodiment shown in FIG. 3a the male profiles 35 and/or the female profiles 25 are printed directly on the plate 22, 32 positioned on a cylindrical support 91.

As said, according to a further embodiment, the male profiles 35 and/or the female profiles 25 are printed directly on the plate 22, 32 fixed on a cylinder 20, 30 of the treating machine.

According to an aspect of the present invention, the profiles are printed by a device 200 for preparing plates 22, 32 indicated below for the sake of simplicity also as 3D printer, provided with a nozzle 80, preferably a heated nozzle, which prints polymeric material on the plate in the form of a plurality of layers 70 which, by superimposition, form the treating profile element 25, 35.

Deposition of the polymeric material is performed for example by means of a motor (not shown) positioned upstream of the nozzle 80 which pushes a strip, or wire, or filament of polymeric material, preferably thermoplastic polymeric material, through the nozzle 80.

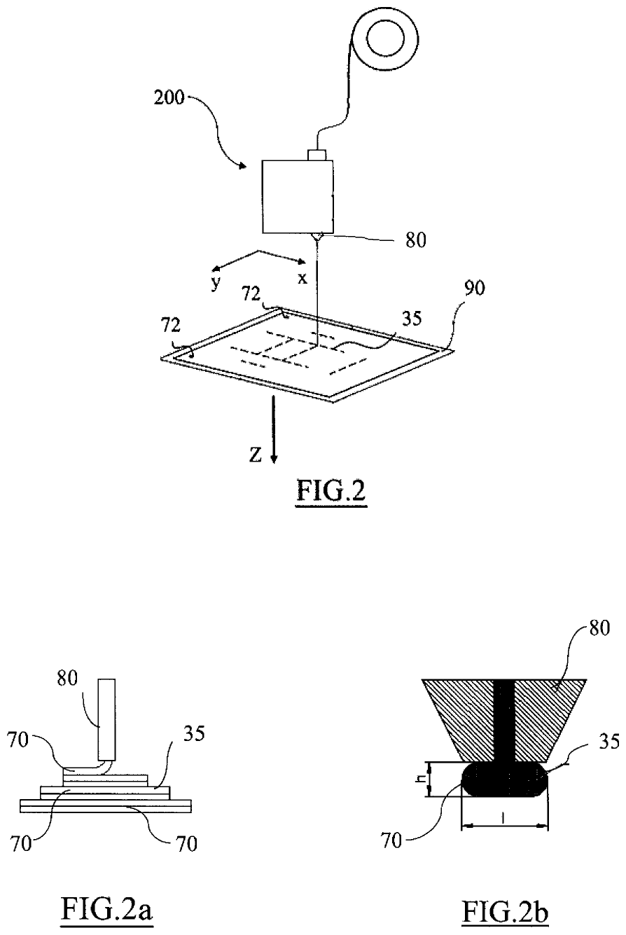

As shown schematically in FIGS. 2, 3a, 3b for example, the polymeric material is preferably fed from a reel in which the polymeric material is present in the form of a wound strip, or wire, or filament. However, further methods of feeding the polymeric material to the nozzle 80 are not excluded.

Preferably, heating of the nozzle 80, or the presence of a heating chamber, upstream of the nozzle, allows the polymeric material to be brought to a substantially fused condition so that it can pass through the nozzle and be deposited on the plate surface 22, 32 or on a layer 70 of previously deposited polymeric material.

As said, according to an aspect of the invention, the material for the printing is preferably polymeric material, more preferably thermoplastic material, for example PETG, and is delivered from the nozzle 80 in the form of a wire or filament, preferably at high temperatures.

According to possible embodiments, the heated nozzle 80 has an outlet diameter between 2 mm and 6 mm, preferably 4 mm.

The filament of thermoplastic material is deposited on the plate 22, 32, in a substantially fused state. The filament, or wire, of material deposited cools and solidifies, adhering to the plate.

The 3D printer 200 can be provided with temperature control means, not shown in the figure, adapted to maintain the supporting plane 90 heated, or the cylindrical support 91 or the cylinder 20, 30 at the desired temperature.

If the plate 22, 32 is fixed to the supporting plane 90, the layers 70 of fused material are deposited on the plate so as to adhere to a flat rectilinear surface. Consequently, the first layer deposited 70 will have a substantially flat shape.

If the plate 22, 32 is fixed to a cylindrical support 91 or to a treating cylinder 20, 30, the layers 70 of fused material are deposited on the plate so as to adhere to a curved surface. Consequently, at least the first layer deposited 70 will have a substantially curved shape, having a curvature equal to that of the cylindrical surface on which it lies.

After the cooling and solidification process of the treating profile elements 25, 35 has been completed, said elements adhere perfectly and in a permanent manner to the plate 22, 32 below.

At this point, if the additive manufacturing operation (and in particular printing) is carried out on a plate 22, 32 positioned on a supporting plane 90 or on the cylindrical support 91, the plate 22, 32 is removed from the supporting plane 90 and secured to one of the two rollers by fastening means 24.

If the additive manufacturing operation (and in particular printing) is performed on a plate 22, 32 positioned on the cylinder 20, 30, said intermediate operation is not necessary, and the treating cylinder 20, 30, is appropriately positioned inside the treating machine.

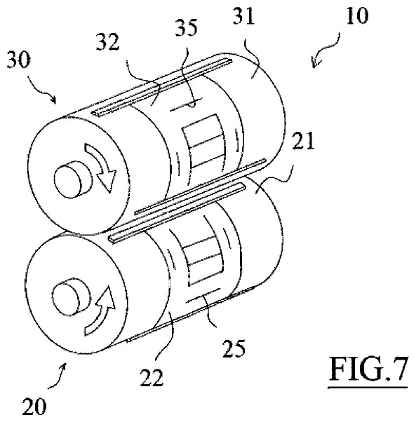

Once the rotation of the pair of rollers 10 has been activated, as can be seen for example in FIGS. 1 and 7, the interposition of an item of the paper processing industry such as, for example, a cardboard 40 or a greetings card or a card stock for producing packaging or micro-packaging boxes or other items of the paper processing industry, between the male profiles 35 of the upper cylinder 32 and the complementary female profiles 25 of the lower cylinder 22 allows the treating 60 to be carried out on the cardboard 40.

Obviously, it should be noted that the distance between the upper cylinder 30 and the lower cylinder 20 can be adjusted according to the thickness of the cardboard 40 to be treated.

Going back to the printing of the male profiles 35 (or female profiles 25) on the upper plate 32 (or on the lower plate 22), as said, it is carried out by means of an additive manufacturing process, preferably by means of a 3D printer 200, which operates according to the 3D reference model of the treating profile elements 25, 35. In other words, printing of the portions, or elements, with male profile 35 (or female profile 25) on the upper plate 32 (or on the lower plate 22), is guided by a specific software (called Slicer in the additive manufacturing sector), in which the parameters of the additive manufacturing process can be entered and/or modified, such as, for example, the material used for the printing, the diameter at which the wire of material for the printing shall be deposited, the height (or thickness) desired for each layer 70 of each treating profile element, the displacement speed of the nozzle (80) relative to the deposition surface, the delivery speed of the material, the infill (or filling) desired for each layer 70, the printing temperature, or any combination of the preceding parameters.

According to one aspect of the invention, the profile elements are preferably made of PETG, but can also be made of ABS (acrylonitrile-butadiene-styrene), PLA (polylactic acid), HIPS (high-impact polystyrene), TPU (thermoplastic polyurethane), nylon, or any other thermoplastic material that can be used in an additive manufacturing process.

According to an aspect of the present invention, the polymeric material used has a Shore hardness of approximately 80-100 on a type A Shore scale.

The layers 70 deposited can be made of different polymeric materials or using different deposition parameters such as, for example, one or more of the parameters referred to above. Preferably the polymeric materials are compatible with one another to obtain a better reciprocal adhesion of the layers.

FIGS. 2a, 4a and 4b show for example some possible embodiments of the shape of the treating profile elements 35, obtained by means of successive deposition of several layers 70 of polymeric material. FIG. 4c shows a possible embodiment in which the treating profile element 35 is made by means of the deposition of layers 70 of different materials (see the different crosshatching of the layers).

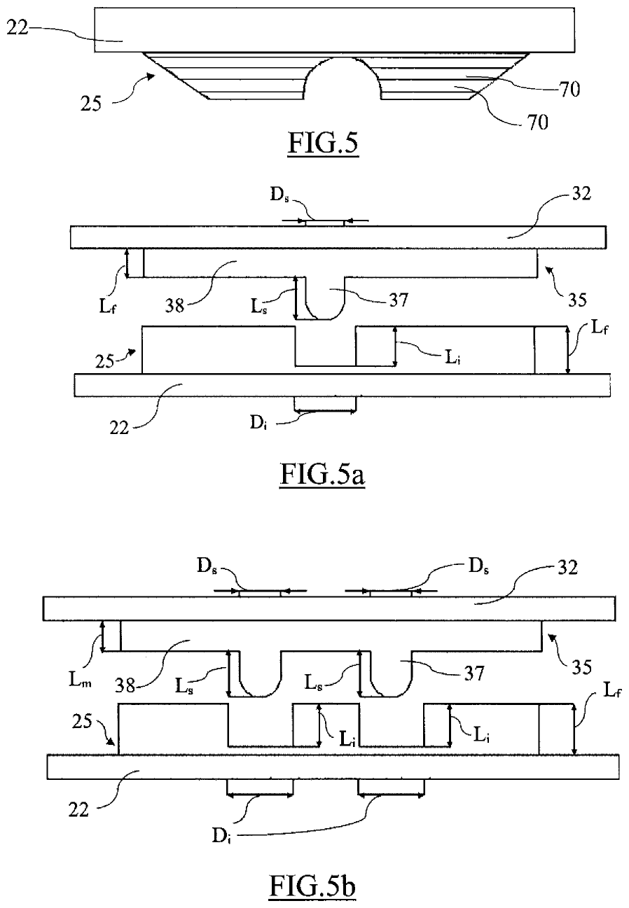

FIGS. 5a and 5b show a section view of two possible embodiments of treating profiles according to the invention.

The male and female profiles 35, 25 have predefined dimensions, namely the profiles are printed on the respective plates 22, 32 so that the male profile 35 has a lower supporting portion 38 with height Lₘ and a projecting portion 37 with height Lₛ and width Dₛ, while the female profiles 25 have a height L_{f} with hollows of depth Lᵢ, and width Dᵢ adapted to house the projecting portions 37 of the male profiles 35.

For example, as shown in FIGS. 5a and 5b, the dimensions of the male profiles 35 are such that the lower supporting portion 38 has a height Lₘ of less than 0.8 cm, preferably equal to 0.6 cm, and the projecting portion 37 has a height Lₛ of less than 1 cm, preferably equal to 0.85 cm. The width Dₛ of the projecting portion 37 is less than 1 cm, preferably it is equal to 0.8 cm.

The dimensions of the female profiles 25 are such that the height Lₘ is less than 1.5 cm, preferably equal to 1 cm, and the hollow has a depth Lᵢ less than 1 cm, preferably equal to 0.8 cm. The width Dᵢ of the hollow is less than 1.5 cm, preferably it is equal to 1.3 cm. As can be noted for example from FIGS. 5a and 5b, according to an aspect, the height Lₛ of the projecting portion 37 of the male profile 35 is preferably greater than the depth Lᵢ, of the female profile, so that during the treating only the portions of the item of the paper processing industry to be processed (folded or embossed) come into contact with the creasing profiles.

As shown for example in the figures, according to an aspect of the invention, the section of the male treating profile 35 can comprise at least a curved surface, and preferably an end having curved or circular shape (see for example the embodiments of FIGS. 5a, 5b), or can have a flat end or upper surface. The two sides of the section can be parallel to each other and rectilinear or at least one of the two sides can be inclined so as to be incident. The material used for deposition on the plate and/or on a previously deposited layer 70, and therefore for the printing, for example the thickness (height h) of each layer 70, the width (l) of the printed layer (see for example FIG. 2b), the filling percentage of the layers 70 printed by the nozzle 80 of the 3D printer 200, or a combination thereof, are appropriately chosen to allow precise and clear realization of the profile elements. For example, printing parameters can be selected such that the wire of material printed by the nozzle 80 has a diameter between 2 mm and 6 mm, preferably 4 mm, and each layer of material has a thickness of 0.1 mm-2 mm.

The printing temperature is adjustable for each material, and varies in a range of values between 180° C. and 300° C., preferably between 200° C. and 290° C.

At said temperatures, the printed thermoplastic material is in a substantially fused state when it is deposited on the plate 22, 32. When it cools, the polymeric material returns to the solid state, adhering perfectly to the plate 22, 32.

According to an aspect of the present invention, to facilitate adhesion of the profile elements 25, 35 to the plate 22, 32, the supporting plane 90 or the cylindrical support 91 or the cylinder 20, 30 to which the plate 22, 32 is secured, on which said profile elements 25, 35 are printed, is maintained at a temperature with values ranging from 100° C. to 120° C., preferably between 110° C. and 115° C.

According to a further aspect of the invention, additives with binding properties can be sprayed on the plate 22, 32 prior to the printing operation, to further facilitate said adhesion. Said additives are preferably such as not to leave residues on the plate.

According to an aspect of the invention, an additive manufacturing device is used, preferably a 3D printer 200 for fused deposition modelling, comprising a heated nozzle 80 and a supporting plane 90 or a cylindrical support 91 for the plate 22, 32. The nozzle 80 can be guided along at least one axis (X), preferably along two axes and thus along a plane X-Y by a CAM software, in accordance with the 3D reference model of the treating profile elements to be printed. The nozzle 80 can be guided according to different types of kinematics, for example, according to core XY kinematics or gantry kinematics.

In the embodiment shown in FIG. 2, in which the plate is positioned on the supporting plane 90, the kinematics used are preferably of core XY type, according to which the nozzle 80 is moved along the plane X-Y parallel to the plane on which the supporting plane 90 lies, while the supporting plane 90 on which the plate 22, 32 is arranged is movable along an axis Z perpendicular to the above-mentioned plane X-Y along which the nozzle 80 moves. It should be noted that embodiments are also possible in which the relative movement along the Z axis between the supporting plane 90 and the nozzle 80 can occur by means of movement of the latter relative to the supporting plane 90, which can be fixed.

A section view of a detail of the treating profile element is shown in FIG. 2a. In particular, it should be noted that the layers 70 of material are deposited on the plate 22, 32 so as to form portions generally having a rectilinear extension.

In the further embodiment shown in FIG. 3a, in which the profile elements 25, 35 are printed on the plate 22, 32 positioned on the cylindrical support 91, the nozzle 80 is moved in at least one direction X (parallel to the axis of the cylinder 91) and if necessary can also be moved in the direction Y, perpendicular to the direction X, and therefore be movable along the plane X-Y.

The cylindrical support 91 on which the plate 22, 32 is arranged can be movable along an axis Z perpendicular to the axis X (or relative to the above-mentioned plane X-Y) along which the nozzle 80 is movable. It should be noted that the movement along the vertical axis Z can be obtained also by vertically moving the nozzle 80 and maintaining the support cylinder 91 fixed.

Furthermore, according to a further possible embodiment, the cylindrical support 91 can be rotated around its own central axis (for example via a motor 91a connected to the support cylinder 91 for example by means of a drive belt), which therefore constitutes the rotation axis.

The printing process of the 3D reference model of the treating profile elements 25, 35 is carried out in a controlled manner, through a CAM control software, so as not to involve the parts of the plate 22, 32 on which no portion of profile element 25, 35 has to be printed.

Advantageously, according to an aspect of the present invention, the 3D reference model of the treating profile elements to be printed on the plates 22, 32 is determined and then produced with a 3D modelling software, according to the treating pattern 50. The pattern 50 can be stored in a memory unit 130 associated with a control unit 110 of the plate preparation device, and in particular of the 3D printer used.

As discussed above, the 3D model of the treating profile elements 25, 35, and in particular the shape and/or the dimensions of said elements and/or the relative distance that said elements shall maintain when printed on the same plate 22, 32, are determined according to the treating pattern 50 to be produced. Determination of the shape, dimensions and positioning of the profile elements on the plate can be advantageously carried out by the control unit 110, according to the desired treating pattern 50.

In other words, the 3D model of the treating profile elements to be printed on the plate 22, 32 by means of an additive manufacturing process preferably performed by a 3D printer 200 is obviously defined according to the desired treating pattern 50 and is therefore determined or calculated based on it.

For example, the shape and the dimensions of the 3D reference model of the profile elements, and the relative distance which said elements shall maintain when printed on the same plate, can be determined according to the shape and dimensions of the treating profile which is applied on the plate. In further detail, for example the dimensions and the shape of the lower supporting portion 38 of the treating profile (on which an upper projecting or hollow portion 37 can be printed, without interruption) are taken into consideration for production of the 3D reference model according to the acquired pattern 50.

For example, according to an embodiment adapted to carry out creasing of an item of the paper processing industry, the shape of the profiles can be rectangular or another polyhedral shape, for example of the type shown in FIG. 6 where two male profiles 35 are shown adapted for a creasing operation, seen from above.

In particular, the profile has a projecting upper portion 37 which is positioned without interruption on a lower supporting portion 38, where the support 38 has a hexagonal shape with, at its ends, oblique sides 39 that define an angle a equal to or smaller than 90°, preferably an acute angle smaller than 45°.

FIG. 6a shows for example two adjacent male profiles 35 seen from above for the realization of two reciprocally inclined creasing lines.

It should be noted in general that the treating lines of the pattern 50 correspond preferably to the projecting portions 37, or hollows (shown for example in FIG. 5 and in the lower part of FIGS. 5a, 5b), which are arranged on the support 38. The treating profile elements, having a generally rectilinear extension, which are printed on the plate 22,32, are produced in such a way that the projecting portion 37 (or the hollow) determines the desired creasing line based on the pattern 50.

The same concepts relative to the shape of the support can be applied to the female profiles where the upper portion 37 is printed with hollow shape (not shown in the figures for the sake of simplicity).

In a further embodiment adapted to carry out embossing on an item of the paper processing industry, the shape of the profiles can be rectangular or another polyhedral shape.

In particular, the profile has a plurality of upper projecting portions 37 with rounded shape, positioned without interruption on a lower support portion 38 (or directly on the plate), where the support 38 has a rectangular shape.

In a further embodiment, adapted both to embossing and creasing an item of the paper processing industry, on the plate 22, 32 different profiles can be printed, adapted to embossing and creasing respectively, such that the two operations can be carried out simultaneously by the treating machine.

It should be noted, obviously, that the lower support portion may not be present. According to an aspect of the present invention, the movement of the printing nozzle 80 of the 3D printer 200 is controlled by the control unit 110 which has acquired the 3D reference model of the treating profile elements, produced based on the pattern 50 of the treating lines to be obtained.

In an embodiment, as shown for example in FIG. 2 or 3b, the plate 22, 32, is fixed to the supporting plane 90 of the 3D printer by means of reference pins (or dowels) 95, inserted in reference holes 72 of the plate, so as to form an assembly 92 comprising the plate, which is in turn arranged on the supporting plane 90. Below, said assembly is also called flat treating complex 92.

The reference pins or dowels 95 engage with the relative reference holes 72 present in the plate 32.

In a further embodiment, shown in FIG. 3a, the plate 22, 32, is fixed to the cylindrical support 91 of the 3D printer due to the magnetic force between the sheet 22, 32 made of magnetized polymeric material and the support 91, for example metallic, so as to form the assembly 92 comprising the plate. Below, said assembly is also called curved treating complex 92.

The treating complexes (or assemblies) 92, 93 allow precise effective printing of the male profiles 35 and female profiles 25 on the plates 22, 32, since they constitute a solid and stable support during the printing operation.

As said, according to a possible embodiment, a preparatory step can comprise heating of the supporting plane 90 and the support cylinder 91 and possible addition of additives on the plate 22, 32 prior to the step of printing the profile elements 25, 35.

According to a possible embodiment, the preparation device for preparing the plates and in particular the 3D printer 200 is provided, or is associated, with a control unit 110 for printing the male and/or female profile elements.

In further detail, according to a possible embodiment, as shown for example schematically in FIGS. 3a, 3b, male profile elements 35, or female profile elements 25, are printed by a 3D printer 200 coupled with a control unit 110. The control unit 110 is associated with a memory unit 130. The 3D printer 200 can deposit (as said, by means of printing, for example) portions of wire or filament of polymeric material which form the layers 70 of which each element (portion) of treating profile 25, 35 is composed in accordance with the 3D reference model, namely with length and shape that allows a given portion, or segment, of the treating pattern to be obtained. The control unit 110 controls the printing parameters for printing portions (or segments) of wire of polymeric material which will form the layers 70 of the treating profile elements such as, for example, the movement pattern performed by the print nozzle 80 in terms of coordinates X-Y (or movement along at least an axis X), lowering or raising of the supporting plane 90 of the 3D printer 200 along the axis Z perpendicular to the plane X-Y of said surface, speed and amplitude of rotation of the cylindrical support 91 around its axis, lowering or raising of the cylindrical support 91 along the axis Z perpendicular to the plane X-Y, diameter of the wire, filling percentage for each layer 70, height (h) of the nozzle 80 relative to the deposition surface, displacement speed of the nozzle (80) relative to the deposition surface, material delivery speed, printing temperature, temperature of the supporting plane 90 or of the cylindrical support 91 of the 3D printer, printing order of the profile elements, or any combination of the preceding parameters.

According to an aspect of the present invention, to obtain the treating profile elements 25, 35 with the desired geometries and dimensions, the control unit 110 coordinates the height (h) and the displacement speed of the nozzle (vₙ), relative to the printing surface, and the delivery speed (v_{f}) of the filament of polymeric material fed into the nozzle 80. The theoretical model of the section of the wire printed at the outlet of the deposition nozzle is shown, for example, in FIG. 2b. As shown schematically in FIG. 2b, for example, I and h are respectively the width and the height of the wire to be obtained by means of the printing nozzle 80.

The volumetric flow rate \dot{V} is given by

$$\dot{V} = {v}_{n} ( ( l - h ) h + \frac{π {h}^{2}}{4} )$$

The volumetric flow rate at the inlet, on the other hand, is defined by the dimension of the section of the wire or filament of the incoming polymeric material:

$$\dot{V} = {v}_{f} \frac{π {D}_{f}^{2}}{4}$$

Since the flow rate at the inlet and at the outlet is the same, it is possible to relate the delivery speed with the displacement speed of the nozzle. The height is coordinated independently. In this way it is possible to control the dimension of the section of the printed wire and, consequently, the geometries and dimensions of the section of the treating profile elements 25, 35 that can be obtained.

According to an aspect, the step of adhesion of the profile elements 25, 35 to the plate 22, 32, begins simultaneously with the beginning of the printing step. When the wire is deposited on the plate 22, 32, it is in a substantially fused state, at high temperature, preferably in a range of temperature values between 180 and 400° C., and as it cools layer after layer it solidifies, adhering to the plate 22, 32 below.

According to an aspect of the present invention, the printing operation and consequent adhesion of the profile elements 25, 35 is guided by the control unit 110 which displays the treating pattern on a screen 140 to facilitate monitoring of the operation by the operator.

According to a possible embodiment, the control unit 110 allows display of the printing operation control parameters on a screen 140 in order to assist the operator and speed up the operations.

The operator can select different printing parameters for each portion (element) of male profile 35 according to the treating pattern 50 to be produced.

FIG. 4 shows a section of the creasing complex 92, 93 once the male profiles 35 have been printed in accordance with the 3D reference model.

Following the same procedure as used for the upper plate 32, the lower plate 22 can be provided with female profiles 25.

The upper plate 32 provided with the male profiles 35 is detached from the supporting plane 90 or from the cylindrical support 91 and fixed to the upper cylinder 30 by means of the fastening means 24 or by means of magnetic force.

Following the same procedure used for the upper plate 32, the lower plate 22 can be provided with female profiles 25 and fixed to the lower cylinder 20 by means of the fastening means 24 or by means of magnetic force.

The preparation step of the pair of rollers 10 described is shown, for example, in FIG. 7 and is performed with the upper cylinder 30 and the lower cylinder 20 not in rotation.

The male profiles 35 adhere to the upper plate 32 which is positioned on the outer surface of the upper cylinder 30, while the female profiles 25 adhere to the lower plate 22 which is positioned on the outer surface of the lower cylinder 20.

By rotating the pair of rollers 10 it is possible to carry out treating of the cardboard 40.

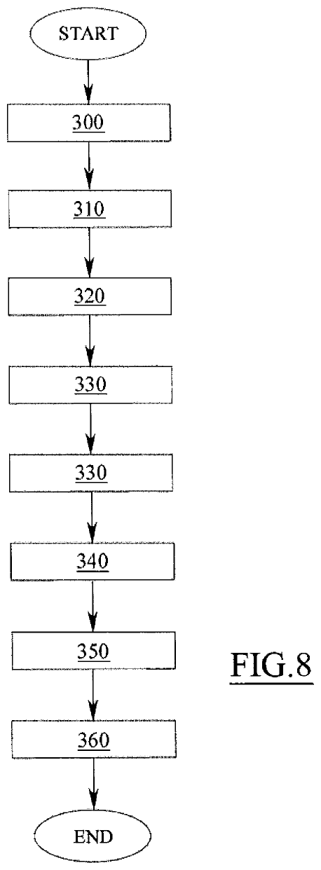

Lastly, FIG. 8 shows a block diagram of a possible embodiment of the process of the invention.

In particular, the process according to the possible non-limiting embodiment comprises acquisition by a control unit 110, for example in a memory unit 130 associated with it, of a treating pattern 50 (block 300).

This step can serve for example to acquire a file in one of the known formats, for example the .pdf format, contains a plurality of information such as, for example, the graphics of the pattern to be printed on the card stock, a layer with the profile to be die-cut and another layer containing the treating pattern.

According to an aspect of the invention, in the process, the treating layer is automatically chosen and according to the treating lines and/or dots and/or shapes (and in general the profile), a 3D reference model of the treating profile elements to be made (block 310) is created by means of a 3D modelling software, for example the shape is determined (for example hexagonal) and/or the dimensions (for example the length) of the lower support portion 38 of the treating profile to be applied on the plate 22, 32 to obtain one or more treating portions of the pattern 50; the relative distance between the profile elements that shall be maintained during the printing is also determined, in accordance with the pattern 50. Said reference model is saved as a file in a format suitable for 3D printing (vector format, set (sequence) of *dxf or *plt* for example .stl file, or a CAD model usable for 3D printing).

The parameters saved in said file suitable for 3D printing are used by the 3D printer 200 to print the treating profiles 25, 35 on the plate 22, 32.

A plate 22,32 to be prepared is fixed on a supporting plane 90 or on a cylindrical support 91 (block 320) of the 3D printer 200. The supporting plane 90 or the cylindrical support 91 can be heated and/or the plate 22, 23 can be furthermore sprayed with additives, in order to increase the adhesion capacity with the treating profile elements 25, 35 which are printed (block 330). As said, this step is optional, for example if the material deposited and the material of the plate are chosen so as to allow effective adhesion of the material deposited on the plate. For example, as said, by depositing PTEG on a PVC plate, the applicant obtained effective adhesion that does not require heating of the plate and/or the addition of additives such as adhesives.

This is followed by a step of printing of the treating profile elements according to the 3D reference model, in accordance with the pattern 50 (block 340).

As said, the step of printing treating elements on a plate 22,23 in accordance with the 3D reference model is performed preferably by means of an additive manufacturing process, and in particular by means of a 3D printer 200 having a print nozzle 80 of polymeric material, and which can be moved in a known manner, for example preferably according to core XY kinematics for formation of the layers 70 which, by superimposition, form the treating profile element 25, 35.

A 3D printer 200 is then activated, by means of a control unit 110, to print, through the nozzle 80, segments of polymeric material which are deposited on the plate 22, 23 forming the layers 70 which, by superimposition, constitute the treating profile elements.

The nozzle 80 deposits the wire following XY kinematics, remaining fixed relative to the vertical axis Z, while the supporting plane 90 of the printer 200 moves along the axis Z perpendicular to the plane X-Y or the cylindrical support 91 moves along the axis Z and/or rotates around its axis, according to formation of the layers 70. In further detail, according to a possible embodiment, the surface 90 or the cylindrical support 91 move in the direction of the axis Z as the printing operation proceeds, in order to create the space necessary for the superimposition of further layers 70.

It should be noted that if a cylindrical support 91 is used to support the plate 22, 32 during deposition of the polymeric material, the nozzle 80 can be moved along an axis X, preferably parallel to the central axis of the cylinder 91.

The wire printed by the nozzle 80 is deposited on the plate in a substantially fused state, to produce the treating profile elements 25,35 according to the parameters set by the operator via the control unit 110 (block 350).

Lastly, after completing the printing operation, the treating profile elements 25,35 are left to cool on the plate 22,32 to which they adhere (block 360).

As described above, the operations for printing the treating profiles of a plate can be repeated for printing profiles, for example complementary profiles, on the second plate.

Obviously modifications or improvements can be made to the invention as described, dictated by contingent or particular reasons, without departing from the scope of the invention.

1. A process for preparing plates (22,32) for cylinders (20,30) to treat items of the paper processing industry (40), the process comprising the following steps:
a) acquisition of a treating pattern (50) to be produced on the item of the paper processing industry (40);
b) creation of a 3D reference model of the treating profile elements (25, 35) according to the treating pattern (50);
c) application of the treating profile elements (25,35) on the plate (22,32) by means of an additive manufacturing process of polymeric material, preferably thermoplastic polymeric material, in accordance with the 3D reference model of the treating profile elements (25, 35), carried out by means of at least one printing nozzle (80) of said polymeric material.

2. The process according to claim 1, wherein said additive manufacturing process is a fused deposition modelling (FDM) process.

3. The process according to claim 1 or 2, wherein said additive manufacturing process is carried out by a 3D printer (200) which comprises said at least one nozzle (80), preferably heated.

4. The process according to any one of the preceding claims, wherein in said application step of the treating profile elements (25,35) on the plate (22,32) by means of an additive manufacturing process of polymeric material, said plate (22, 32) is positioned on a supporting plane (90) or a cylindrical support (91).

5. The process according to claim 4, wherein said plate (22, 23) is fixed to said supporting plane (90) or to said cylindrical support (91) by means of magnetic interaction.

6. The process according to any one of the preceding claims, wherein said polymeric material printed by said nozzle (80) is PTEG and/or said at least one plate (22, 32) is made of polymeric material, preferably PVC.

7. The process according to any one of the preceding claims, wherein the nozzle (80) is movable along at least one axis (X), preferably along at least two axes (X, Y) perpendicular to each other.

8. The process according to any one of the claims from 4 to 7, wherein the supporting plane (90) or the cylindrical support (91) moves at least along a vertical axis (Z).

9. The process according to one of the claims from 4 to 8, wherein said cylindrical support (91) is rotatable around its own rotation axis.

10. The process according to one of the preceding claims, wherein the application of the treating profile elements (25,35) on the plate (22,32) by means of an additive manufacturing process comprises the formation of a plurality of stacked layers (70).

11. The process according to claim 10, wherein the nozzle (80) prints polymeric material, preferably thermoplastic material, preferably in the form of a wire, which is deposited on the plate (22, 32) so as to form a plurality of superimposed layers (70), to produce at least one treating profile element (25, 35) in accordance with the 3D reference model.

12. The process according to claim 10 or 11, wherein at least one layer (70) of polymeric material of at least one treating profile element (25, 35) adheres permanently to the plate (22, 32), preferably as a result of cooling and/or solidification of the polymeric material.

13. The process according to any one of the preceding claims, wherein a step of displaying and/or modification of the deposition parameters of the treating profile elements (25,35) is provided, said deposition parameters of the treating profile elements (25,35) preferably comprising at least the height (h) of the nozzle (80) relative to the deposition surface, the displacement speed of the nozzle (80) relative to the deposition surface, the delivery speed of the material, or any combination of the preceding parameters.

14. A device (250) for preparing plates (22,32) for cylinders (20,30) to treat items of the paper processing industry (40), preferably according to the process according to any one of the preceding claims, the device comprising at least one nozzle (80) for the deposition of polymeric material, preferably thermoplastic polymeric material, on at least one plate (22, 32) by means of an additive manufacturing process for the production of treating profile elements (25, 35) according to a 3D model of the treating profile elements (25, 35).

15. The device according to claim 14, characterized in that it comprises at least one supporting plane (90) or a cylindrical support (91) for the plate (22, 32), said printing nozzle (80) being movable along at least one axis (X), preferably on a plane X-Y substantially parallel to the surface on which said plate (22, 32) lies.

16. A plate (22,32) to treat items of the paper processing industry comprising at least one treating profile element (25,35) of polymeric material, preferably thermoplastic polymeric material, deposited on said plate by means of an additive manufacturing process of polymeric material, preferably by means of a process according to any one of the claims from 1 to 13.
